(19) United States
(12) Patent Application Publication
(10) Pub. No.: US 2014/0270823 A1
(43) Pub. Date: Sep. 18, 2014

(54) ELECTROPHOTOGRAPHIC FIXING DEVICE, FIXING ROTARY MEMBER, IMAGE FORMING APPARATUS, AND FIXING METHOD

(71) Applicants: Tomoaki Sugawara, Kanagawa (JP); Tsuneaki Kondoh, Kanagawa (JP); Junichiro Natori, Kanagawa (JP); Yuko Arizumi, Kanagawa (JP)

(72) Inventors: Tomoaki Sugawara, Kanagawa (JP); Tsuneaki Kondoh, Kanagawa (JP); Junichiro Natori, Kanagawa (JP); Yuko Arizumi, Kanagawa (JP)

(73) Assignee: RICOH COMPANY, LTD., Tokyo (JP)

(21) Appl. No.: 14/205,870

(22) Filed: Mar. 12, 2014

(30) Foreign Application Priority Data
Mar. 14, 2013 (JP) 2013-052169

(51) Int. Cl. G03G 15/20

(52) U.S. Cl. CPC G03G 15/2089
USPC 399/45; 399/67; 399/69

(57) ABSTRACT

An electrophotographic fixing device includes a pressure roller, and a fixing rotary member disposed at a fixed distance away from the pressure roller. The fixing rotary member includes a layer formed of an elastic body. The elastic body includes carbon fibers and hole portions. The electrophotographic fixing device controls pressure of a nip between the pressure roller and the fixing rotary member by a temperature setting according to a sheet type.

### CROSS-REFERENCE TO RELATED APPLICATIONS

This patent application is based on and claims priority pursuant to 35 U.S.C. §119 from Japanese Patent Application No. 2013-052169, filed on Mar. 14, 2013 in the Japan Patent Office, the entire disclosure of which is hereby incorporated by reference herein.

### BACKGROUND

1. Technical Field

Exemplary embodiments of the present disclosure generally relate to an electrophotographic fixing device, a fixing rotary member employed in the fixing device, an image forming apparatus employing the fixing device, and a fixing method.

2. Related Art

In recent years, types of recording materials employed for image forming have been increasing. In accordance with the increase in the types of recording materials, there has been a demand for, particularly, responding to a recording material in which uneven gloss of an icicle shape is exhibited on an image after fixing or a recording material prone to jamming. At present, flow speed and linear velocity of a sheet are changed in accordance with a sheet type. However, from a standpoint of a problem of productivity, making flow speed and linear velocity constant regardless of the sheet type is sought-after.

Publicly known technology responding to the sheet type is disclosed in the following. JP-2010-020129-A, JP-2011-100050-A, and JP-3959556-B1 (JP-H10-228200-A) respond with mechanical measures. JP-2011-257546-A and JP-S61-018751-A respond with temperature settings.

With the mechanical measures, there is a problem of a device becoming large and a problem of an increase in heat capacity around a fixing device leading to an extremely long warm-up time. With the temperature settings, there is a problem of an increase in probability of generating a jam with respect to a thin sheet at high temperature, and energy efficiency also declines. Further, elasticity of a toner declines leading to a problem of inversely generating a hot offset. In addition, there is a problem of defective fixing and, particularly a problem of a decline in gloss level of a color image.

### SUMMARY

In view of the foregoing, in an aspect of this disclosure, there is provided a novel electrophotographic fixing device including a pressure roller, and a fixing rotary member disposed at a fixed distance away from the pressure roller. The fixing rotary member includes a layer formed of an elastic body. The elastic body includes carbon fibers and hole portions. The electrophotographic fixing device controls pressure of a nip between the pressure roller and the fixing rotary member by a temperature setting according to a sheet type.

The aforementioned and other aspects, features, and advantages will be more fully apparent from the following detailed description of illustrative embodiments, the accompanying drawings, and associated claims.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a schematic view of an example of a fixing device according to an embodiment of the present invention;

FIG. 2 is an enlarged view of a circled area of the fixing device of FIG. 1 showing a state of a sheet ejection side in which width of a nip has increased;

FIG. 3 is a schematic view of a configuration of an elastic body including pitch-based carbon fibers and hole portions;

FIG. 4 is a schematic view of an example of an image forming apparatus including the fixing device according to an embodiment of the present invention; and

FIG. 5 is an example of a control flow chart regarding a sheet type setting device, temperature rise, and fixing in the image forming apparatus.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

Hereinafter, exemplary embodiments of the present invention are described in detail with reference to the drawings. However, the present invention is not limited to the exemplary embodiments described below, but can be modified and improved within the scope of the present invention.

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

In view of the foregoing, in an aspect of this disclosure, there is provided a novel electrophotographic fixing device in which a fixing temperature may be made low and responds to change of a sheet type by conducting small changes to a temperature setting.

The following is a detailed description of the electrophotographic fixing device 1) according to an embodiment of the present invention. Features 2) to 8) of the electrophotographic fixing device 1) are included in exemplary embodiments of the present invention, and are also described below.

1) The elect uphotographic fixing device including a pressure roller, and a fixing rotary member disposed at a fixed distance away from the pressure roller. The fixing rotary member includes a layer formed of an elastic body. The elastic body includes carbon fibers and hole portions. The electrophotographic fixing device controls pressure of a nip between the pressure roller and the fixing rotary member by the temperature setting according to the sheet type.

2) The electrophotographic fixing device of 1) further including a pair of rigid members to sandwich the fixing rotary member in which the electrophotographic fixing device controls the pressure of the nip by temperature of a gas of the hole portions.

3) The electrophotographic fixing device of 1) in which a base of the fixing rotary member is a heat resistant resin film or a metal belt.

4) The electrophotographic fixing device of 1) in which the fixing rotary member includes a layer formed of a fluororesin as a release layer at an outermost surface of the fixing rotary member.

5) The electrophotographic fixing device of 1) further including a heating member provided inside the fixing rotary member.

6) A fixing rotary member employed for an electrophotographic fixing device including a sheet type setting device, the fixing rotary member including a layer formed of an elastic body, the elastic body including pitch-based carbon fibers and hole portions.

7) An image forming apparatus including the electrophotographic fixing device of 1).

8) An electrophotographic fixing method used in the electrophotographic fixing device of 1), the method including setting a temperature of a predetermined table with respect to a value from a sheet type setting device, and starting to fix after confirming the electrophotographic fixing device has reached the temperature set by the setting.

The electrophotographic fixing device according to an embodiment of the present invention obtain the following effects of (1) through (6) according to rise of the temperature setting.

(1) A nip portion is provided at a fixed distance between the fixing rotary member and the pressure roller. Thus, when the gas in the hole portions of the elastic body of the fixing rotary member expand according to temperature rise of the heating member, pressure in the nip rises, and fixability is enhanced.

(2) The fixing rotary member sandwiched by the pair of rigid members expand at an outer side of the nip portion toward an anterior and posterior direction of conveyance of a sheet according to expansion of the layer formed of the elastic body of the fixing rotary member. As a result, width of the nip increases and contributes to enhancement of fixability.

(3) The elastic body includes pitch-based carbon fibers. Due to pressure, contact between pitch-based carbon fibers is enhanced. Thus, heat diffusion rate is enhanced. The enhancement of heat diffusion rate also contributes to enhancement of fixability.

A synergistic effect of the above-described three effects (1) to (3) is generated in the fixing device according to an embodiment of the present invention compared to a conventional fixing device in which only an effect of increase in amount of heat applied to a toner is obtained by heat from temperature rise. Accordingly, responding to a thick sheet and a thin sheet without lowering heat efficiency is possible, and the image forming apparatus having a constant productivity and linear velocity may be provided.

(4) Due to increase in the width of the nip and rise of pressure in the nip, fixing is possible with small temperature changes with respect to change of the sheet type.

(5) By employing the above-described elastic body, heat conductivity is increased and fixing at a lower temperature is possible.

(6) Due to detailed setting of the sheet type setting device, fixing at a low fixing temperature is possible.

In addition, features 2) to 8) include the following characteristics and effects of (7) through (12).

(7) As described in feature 2), by sandwiching the fixing rotary member with the pair of rigid members, increase of width of the nip and rise of pressure in the nip becomes large.

(8) The fixing rotary member has to efficiently adhere to the sheet. Thus, it is to be noted that the fixing rotary member is flexible, and has heat resistance. The heat resistant resin film or the metal belt of feature 3) satisfies flexibility and has heat resistance, and are preferable as the fixing rotary member.

(9) According to feature 4), by employing the fluororesin as the release layer at the outermost surface of the fixing rotary member, transfer of the toner to the fixing rotary member side may be prevented.

(10) According to feature 5), by heating from inside of the fixing rotary member, heat from a heater may be efficiently used compared to heating from outside of a fixing member.

(11) According to feature 7), the image forming apparatus that responds to a wide range of the sheet types, saves more energy, and conducts fast switching between the sheet types by responding to the sheet types with small temperature changes is obtained.

(12) According to feature 8), switching to a temperature according to a determination of the sheet type is obtained, and jamming due to excessively high temperature may be prevented even in a case in which the thin sheet is passed through right after the thick sheet.

Referring now to the drawings, exemplary embodiments of the fixing device, the fixing rotary member, and the image forming apparatus of the present invention are described in detail below.

FIG. 1 is a schematic view of an example of a fixing device 100 according to an embodiment of the present invention. A principle of high heat conductivity due to an increase in the width of a nip is shown. FIG. 2 is an enlarged view of a circled area E of the fixing device 100 of FIG. 1 showing a state of a sheet ejection side in which the width of the nip has increased. It is to be noted that a state of a sheet feeding side is the same as the state of the sheet ejection side.

In FIG. 1, a distance between a stay 101 for maintaining the nip and a pressure roller metal core 102 is fixed. The fixed distance is a design specification and is designed to form a desired width of the nip when a predetermined force is applied. For example, in a case of making the width of the nip small, a soft rubber is selected or a distance between rigid members is shortened. Preferably, a thickness of a fixing rotary member 103 is in a range from approximately 150 μm to approximately 600 μm. For example, when the thickness of the fixing rotary member 103 is 200 μm, a diameter of the fixing rotary member 103 is 30 mm, and a diameter of a pressure roller 104 is 30 mm, a distance from a center of the pressure roller metal core 102 to a contact surface of the fixing rotary member 103 of a nip forming member 105 is approximately 14.5 mm.

With respect to FIG. 1, gas in hole portions of the layer formed of an elastic body of the fixing rotary member 103 expands as temperature rises. A halogen heater 106 serving as the heating member supplies heat. In other words, volume expansion ratio of the elastic body of the fixing rotary member 103 with respect to temperature is overwhelmingly large compared to a conventional fixing rotary member including an elastic body such as solid silicone rubber having no hole portions. As a result, pressure in the nip portion provided at the fixed distance rises, and the fixing rotary member 103 expands according to expansion of the layer formed of the elastic body and deforms at the pressure roller 104 side of the nip shown as a nip increase portion F in FIG. 2. Accordingly, the width of the nip increases. With the conventional elastic body such as solid silicone rubber having no hole portions, only an effect of “A: an effect of enhancement of softening of a toner” is obtained. According to an embodiment of the present invention, three effects of “A: an effect of enhancement of softening of a toner,” “B: an effect of pressure rise,” and “C: an effect of increase of the width of the nip” are obtained.

FIG. 3 is a schematic view of a configuration of the elastic body including pitch-based carbon fibers 201 and hole portions. The elastic body is assumed to be employed for a side that provides the heating member. Bubble portions 202 serving as hole portions contributes to “B: an effect of pressure rise” and “C: an effect of increase of the width of the nip.” Further, by making the pitch-based carbon fibers 201 efficiently contact each other, heat is easily transmitted from the heater side to an outside direction (a pressure roller side in the nip). With the configuration of FIG. 3, an effect of “D: an effect of enhancing contact between carbon fibers in the nip due to pressure rise” is obtained along with the above-described three effects. The above-described effect of D: is obtained due to the pitch-based carbon fibers 201 being rigid and unable to deform, and the bubble portions 202 and a rubber being able to easily deform. As a result, heat conductivity is enhanced by contact between the rigid pitch-based carbon fibers 201. Heat conductivity of a material as a whole is largely dependent on contact between the pitch-based carbon fibers 201 due to the pitch-based carbon fibers 201 having extremely high heat conductivity. In the elastic body according to an embodiment of the present invention, heat conductivity increases according to enhancement of contact between the pitch-based carbon fibers 201 due to pressure rise.

The pitch-based carbon fibers 201 are obtained by carbonizing pitch precursor (e.g., pitch fiber obtained from coal tar or heavy petroleum fractions as raw material). According to conditions of manufacture, properties in a broad range from low elastic modulus to extremely high elastic modulus/high strength are obtained and are commercially available. The extremely high elastic modulus pitch-based carbon fibers have good heat conductivity and good electrical conductivity. A specific example of commercially available pitch-based carbon fibers is carbon fiber milled: XN-100-05M (from Nippon Graphite Fiber Co., Ltd.). Heat conductivity of carbon fiber milled: XN-100-05M is 500 W/mk. By contrast, heat conductivity of polyacrylonitrile (PAN)-based carbon fibers is 50 W/mk at maximum. In addition, subjecting the pitch-based carbon fibers to sieving and airflow to classify the pitch-based carbon fibers, and employing short pitch-based carbon fibers is effective.

FIG. 4 is a schematic view of an example of the image forming apparatus including the fixing device according to an embodiment of the present invention. A sheet type setting device not shown in FIG. 4 sets information regarding a sheet P for image forming. Details regarding setting information are described later in FIG. 5.

In the image forming apparatus, a photoreceptor 1 is charged with a charger 301, an electrostatic image is optically or electrically formed on the photoreceptor 1 with a writing system 302, and the electrostatic image is developed with a toner by a developer 303 to form an image. Then, the image is transferred by a transfer roller 304 to the sheet P and the transferred image is, for example, fixed to the sheet P by feeding the sheet P having the transferred image through the fixing device 100 of FIG. 1. Then, the photoreceptor 1 is cleaned by a cleaning device 305.

FIG. 5 is an example of a control flow chart regarding the sheet type setting device, temperature rise, and fixing in the image forming apparatus. Various types of the sheet type setting device may be employed in the image forming apparatus. The simplest sheet type setting device sets information of a sheet via a control panel according to each tray in which the employed sheets are placed. For example, the following may be designated. Tray 1 is thin sheets, tray 2 is normal sheets, tray 3 is medium thickness sheets, and tray 4 is thick sheets. The above-described designation is a sheet type setting S101 of internal trays in the image forming apparatus.

Next, a sheet selection S102 is conducted in a state of having sheet information (i.e., the sheet type setting S101). One of the above-described trays is selected by selecting “1: by user” or “2: by automatic selection of image forming apparatus.”

In the next step, an image is read S103 (in case of copying), and a setting data corresponding to a selected sheet of the sheet selection S102 is searched S104 in a parallel process. Then, for example, a sheet type table (i.e., a sheet type table of the setting data having data of fixing temperature, toner amount, etc.) corresponding to thin sheets of tray 1 is searched S105. With the data searched from the sheet type table, a heater output S106 is controlled by applying a temperature setting from the sheet type table of the setting data and present temperature of the fixing device. Then, image forming is started S107 and fixing and image output is conducted.

According to an embodiment of the present invention, the above-described flow is effective because the above-described effect of “B: an effect of pressure rise” and “C: an effect of increase of the width of the nip” are obtained.

There is no restriction regarding a foamed particle for forming hole portions employed for an embodiment according to the present invention. The foamed particle may be appropriately selected from commercially available foamed particles. Specific examples of foamed particles include, but are not limited to, 100CA, 80CA, F-80ED, F-30E, F-50E, F-80SDE, and FN-80SDE (from Matsumoto Yushi-Seiyaku Co., Ltd.).

A material for the elastic body is preferably silicone rubber. Specific examples of commercially available silicone rubber include, but are not limited to, DY35-2083 (from Dow Corning Toray Co., Ltd.) and KE1950-30 (from Shin-Etsu Chemical Co., Ltd.).

The fluororesin employed for an embodiment according to the present invention preferably has good melt film forming properties in a firing procedure, and has a comparatively low melting point. Preferably, the comparatively low melting point is in a range from approximately 250° C. to approximately 300° C. More specifically, the fluororesin includes, but are not limited to, fine powders of low molecular weight polytetrafluoroethylene (PTFE), tetrafluoroethylene/hexafluoropropylene copolymer (FEP), and tetrafluorothylene/perfluoroalkyl-vinylether copolymer (PFA). In addition, a tube shaped fluororesin may be also employed.

### EXAMPLES

Further understanding can be obtained by reference to specific examples, which are provided hereinafter. However, it is to be understood that the embodiments of the present invention are not limited to the following examples.

### Examples 1 to 3 and Comparative Examples 1 to 3

### Manufacture (1) of Fixing Belt

### Fixing Rotary Member

The following procedure is conducted. A dispersion liquid of an unhardened addition type liquid state silicone rubber dispersed with a foamed particle: F-800SDE (diameter approximately 30 μm, from Matsumoto Yushi-Seiyaku Co., Ltd.), and pitch-based carbon fibers milled: XN-100-05M (length approximately 50 μm, from Nippon Graphite Fiber Co., Ltd.) is prepared. The employed silicone rubber is DY35-2083 (from Dow Corning Toray Co., Ltd.).

Next, the above-described dispersion liquid is applied to a 200 μm thickness on a nickel thin belt having 40 μm thickness manufactured by nickel electrocasting, and hardened in a first hardening. Next, after further hardening in a second hardening, a PFA resin tube (OF tube from Gunze Limited) is bonded on the outside of the above-described dispersion liquid on the nickel thin belt. Accordingly, a fixing belt having an outer diameter of ±30 mm is prepared. Thus, a fixing belt of examples 1 to 3 and comparative examples 1 to 3 are prepared. Blend is shown in Table 1.

TABLE 1

| | | Example | Example | Example | Comparative | Comparative | Comparative |
|---|---|---|---|---|---|---|---|
| Blend (Parts by weight) | | 1 | 2 | 3 | Example 1 | Example 2 | Example 3 |
| Silicone rubber | | 100 | 100 | 100 | 100 | 100 | 100 |
| Carbon | XN-100-05M | 20 | 40 | 60 | 0 | 40 | 0 |
| Fibers | PAN-based | 0 | 0 | 0 | 0 | 0 | 40 |

| | | | | | | |
|---|---|---|---|---|---|---|
| F-80SDE | 1.5 | 1.5 | 1.5 | 0 | 0 | 1.5 |

### Example 4 and Comparative Example 4

### Manufacture (2) of Fixing Belt

### Fixing Rotary Member

The procedure of manufacture (1) of fixing belt (fixing rotary member) having the blend of example 2 and comparative example 2 is repeated except for replacing the nickel thin belt serving as a base with polyimide film (from Gunze Limited) having 40 μm thickness. Thus, a fixing belt of example 4 and comparative example 4 is prepared.

### [Evaluation Method]

Each fixing belt of the above-described examples and comparative examples is set in a fixing unit of imagio MP C2201 copier (fhom Ricoh Company, Ltd.). Normally, the fixing unit is configured to apply pressure of a nip with a spring. However, in the evaluation method, the pressure roller is fixed at a position of the spring at room temperature. As a result, a state of the fixing belt including the layer formed of the elastic body having pitch-based carbon fibers and hole portions being sandwiched by rigid members is formed. The fixing unit is set in a fixing test machine in which linear velocity (speed of a sheet passing through) can be changed and a temperature setting of a heater can be changed. The following test is conducted. The results are shown in Table 2 to Table 5. Data in Table 2 to Table 5 other than fixability evaluation is the same. The numerical value on the right side of each column of each example and comparative example is pressure ratio.

### [Fixability Evaluation]

A document for a fixability test has around one hundred letters of a four point size of MS Mincho font and then one hundred letters of a six point size of MS Mincho font sequentially formed from a leading edge of a sheet. The document is output as a monochrome unfixed image on an A4 size Ricoh PPC sheet: type 6000 <70 W> normal paper (ream weight 70 kg). The letters of the above-described monochrome unfixed image is formed 1 mm from the leading edge of the sheet. The above-described forming letters 1 mm from the leading edge of the sheet is a condition in which sheets having a small ream weight are prone to jamming.

In addition, output of the monochrome unfixed image on a PPC sheet: type 6000 <90 W> (ream weight 90 kg), and output of the monochrome unfixed image on a PPC sheet: type 6000 <58 W> (ream weight 58 kg) is conducted.

The temperature setting of the heater of the fixing test machine is changed and the above-described monochrome unfixed images are passed through the fixing test machine at a linear velocity of 190 mm/s. Confirmation of whether or not fixation of the toner is successful after passing through is conducted. Samples are inspected visually and inspected with a magnifying glass, and are evaluated according to the following standards.

### <Evaluation Standard>

Poor: defective fixing (Adherence of a toner to a fixing belt is observed. A phenomenon of transfer of the toner is observed at a portion of the sheet progressed to a length equivalent to a circumferential length of the fixing belt)
Good: No defective fixing is observed
Not Applicable (NA): Jam is generated

### [Measurement of Nip Width]

A nip width is measured with an OHP film: CG3700 (from Sumitomo 3M Limited). The fixing test machine is set to a temperature setting of 150° C. and maintained for 30 minutes. The OHP film is fed to the fixing test machine. When the OHP film has been fed to the middle of the OHP film, rotation of the fixing belt is stopped and maintained for 15 seconds. Then, the fixing belt is rotated again and the OHP film is ejected. A portion of the OHP film corresponding to a nip position at a point in which rotation of the fixing belt is stopped becomes white turbidity. The width of the center of white turbidity portion is determined as the nip width.

### [Pressure Measurement at Temperature Rise]

Pressure rise at temperature rise is measured with a tack test machine Model: TAC-1000 (from Rhesca Corporation) in a position fixed mode. The tack test machine is a probe tack device. In addition, φ 10 mm of a front end of a probe (made of stainless steel) and a sample fixing table (made of stainless steel) below the probe can measure temperature around a surface of a contact portion by thermocouple, and temperature adjustment can be independently conducted.

First, after punching out a φ 10 mm sample of the fixing belt, the PFA surface of the fixing belt is set as an outer side and bonded to the front end of the probe with heat resistant adhesive. Next, at room temperature, the probe is lowered and the position of the probe is fixed when the probe reaches a constant pressure. A load cell is provided on the probe side and load can be measured. Conversion of stress from the front end area of the probe is conducted. Further, temperature of the sample fixing table is raised to a desired measuring temperature, and pressure is measured at the state of the desired measuring temperature. Accordingly, pressure ratio with respect to initial stress (25° C.) at each temperature is calculated.

In a case of sheet type: type 6000 <70 W> (ream weight 70 kg)

TABLE 2

| | | | | | Comparative | Comparative | Comparative |
|---|---|---|---|---|---|---|---|
| | | Example 1 | Example 2 | Example 3 | example 1 | example 2 | example 3 |
| Nip width (mm) | | 8.1 | 7.5 | 7.0 | 5.5 | 5.1 | 7.5 |
| Fixability | 110° C. | Poor, 150 | Poor, 140 | Poor, 130 | Poor, 110 | Poor, 110 | Poor, 140 |
| Pressure | 115° C. | Poor, 155 | Poor, 142 | Poor, 134 | Poor, 112 | Poor, 110 | Poor, 142 |
| ratio (%) | 120° C. | Poor, 160 | Poor, 150 | Poor, 140 | Poor, 114 | Poor, 112 | Poor, 150 |
| Temperature | 125° C. | Poor, 170 | Good, 160 | Poor, 150 | Poor, 118 | Poor, 112 | Poor, 160 |
| setting | 130° C. | Good, 175 | Good, 165 | Good, 154 | Poor, 120 | Poor, 115 | Poor, 165 |
| (° C.) | 135° C. | Good, 180 | Good, 170 | Good, 161 | Poor, 121 | Poor, 117 | Poor, 170 |
| | 140° C. | Good, 182 | Good, 172 | Good, 167 | Poor, 122 | Poor, 122 | Poor, 172 |
| | 145° C. | Good, 185 | Good, 175 | Good, 174 | Poor, 125 | Good, 125 | Poor, 175 |
| | 150° C. | Good, 182 | Good, 175 | Good, 172 | Poor, 122 | Good, 120 | Good, 175 |
| | 155° C. | Good, 183 | Good, 173 | Good, 173 | Good, 123 | Good, 125 | Good, 173 |
| | 160° C. | Good, 182 | Good, 172 | Good, 175 | Good, 122 | Good, 122 | Good, 172 |

In a case of sheet type: type 6000 <90 W> (ream weight 90 kg)

TABLE 3

| | | | | | Comparative | Comparative | Comparative |
|---|---|---|---|---|---|---|---|
| | | Example 1 | Example 2 | Example 3 | example 1 | example 2 | example 3 |
| Nip width (mm) | | 8.1 | 7.5 | 7.0 | 5.5 | 5.1 | 7.5 |
| Fixability | 110° C. | Poor, 150 | Poor, 140 | Poor, 130 | Poor, 110 | Poor, 110 | Poor, 140 |
| Pressure | 115° C. | Poor, 155 | Poor, 142 | Poor, 134 | Poor, 112 | Poor, 110 | Poor, 142 |
| ratio (%) | 120° C. | Poor, 160 | Poor, 150 | Poor, 140 | Poor, 114 | Poor, 112 | Poor, 150 |
| Temperature | 125° C. | Poor, 170 | Poor, 160 | Poor, 150 | Poor, 118 | Poor, 112 | Poor, 160 |
| setting | 130° C. | Poor, 175 | Good, 165 | Poor, 154 | Poor, 120 | Poor, 115 | Poor, 165 |
| (° C.) | 135° C. | Good, 180 | Good, 170 | Good, 161 | Poor, 121 | Poor, 117 | Poor, 170 |
| | 140° C. | Good, 182 | Good, 172 | Good, 167 | Poor, 122 | Poor, 122 | Poor, 172 |
| | 145° C. | Good, 185 | Good, 175 | Good, 174 | Poor, 125 | Poor, 125 | Poor, 175 |
| | 150° C. | Good, 182 | Good, 175 | Good, 172 | Poor, 122 | Poor, 120 | Poor, 175 |
| | 155° C. | Good, 183 | Good, 173 | Good, 173 | Poor, 123 | Good, 125 | Poor, 173 |
| | 160° C. | Good, 182 | Good, 172 | Good, 175 | Poor, 122 | Good, 122 | Good, 172 |

In a case of sheet type: type 6000 <58 W> (ream weight 58 kg)

TABLE 4

| | | | | | Comparative | Comparative | Comparative |
|---|---|---|---|---|---|---|---|
| | | Example 1 | Example 2 | Example 3 | example 1 | example 2 | example 3 |
| Nip width (mm) | | 8.1 | 7.5 | 7.0 | 5.5 | 5.1 | 7.5 |
| Fixability | 110° C. | Poor, 150 | Poor, 140 | Poor, 130 | Poor, 110 | Poor, 110 | Poor, 140 |
| Pressure | 115° C. | Poor, 155 | Poor, 142 | Poor, 134 | Poor, 112 | Poor, 110 | Poor, 142 |
| ratio (%) | 120° C. | Poor, 160 | Good, 150 | Poor, 140 | Poor, 114 | Poor, 112 | Poor, 150 |
| Temperature | 125° C. | Good, 170 | Good, 160 | Good, 150 | Poor, 118 | Poor, 112 | Poor, 160 |
| setting | 130° C. | Good, 175 | Good, 165 | Good, 154 | Poor, 120 | Poor, 115 | Poor, 165 |
| (° C.) | 135° C. | Good, 180 | Good, 170 | Good, 161 | Poor, 121 | Poor, 117 | Poor, 170 |
| | 140° C. | Good, 182 | Good, 172 | Good, 167 | Poor, 122 | Good, 122 | Poor, 172 |
| | 145° C. | Good, 185 | Good, 175 | Good, 174 | Poor, 125 | Good, 125 | Good, 175 |
| | 150° C. | Good, 182 | Good, 175 | Good, 172 | Good, 122 | Good, 120 | Good, 175 |
| | 155° C. | Good, 183 | Good, 173 | Good, 173 | NA, 123 | NA, 125 | NA, 173 |
| | 160° C. | Good, 182 | Good, 172 | Good, 175 | NA, 122 | NA, 122 | NA, 172 |

In a case of sheet type: type 6000 <70 W> (ream weight 70 kg)

TABLE 5

| | | Example 4 | Comparative example 4 |
|---|---|---|---|
| Nip width (mm) | | 7.6 | 5.2 |
| Fixability | 110° C. | Poor, 135 | Poor, 105 |
| Pressure ratio (%) | 115° C. | Poor, 137 | Poor, 105 |
| Temperature setting | 120° C. | Poor, 148 | Poor, 108 |
| (° C.) | 125° C. | Poor, 158 | Poor, 108 |
| | 130° C. | Good, 160 | Poor, 110 |
| | 135° C. | Good, 165 | Poor, 115 |
| | 140° C. | Good, 170 | Poor, 120 |
| | 145° C. | Good, 172 | Poor, 120 |
| | 150° C. | Good, 170 | Good, 120 |
| | 155° C. | Good, 170 | Good, 125 |
| | 160° C. | Good, 170 | Good, 122 |

From the results of Table 2 to Table 4, the following is understood. In examples 1 to 3 of the case of type 6000 <70 W>, the fixing temperature may be made low to a maximum of 30° C. with respect to a same monochrome unfixed image and toner compared to comparative example 1 employing a normal silicone rubber. In examples 1 to 3 of the case of type 6000 <90 W>, fixing may be conducted with little temperature rise similar to examples 1 to 3 of the case of type 6000 <70 W>. From data with respect to the above-described sheet types, the temperature setting is changed to change fixability. For the comparative examples, there is a need to set the temperature high. In addition, there is a case of a comparative example in which no solution is available (cannot respond to a sheet type).

In examples 1 to 3 of the case of type 6000 <58 W>, there is no generation of jamming. As shown in FIG. 2 in which width of the nip is increased, jamming is not generated when passing through a sheet due to deformation of the ejection side of the fixing belt towards the outer side of the nip according to expansion of the layer formed of the elastic body of the fixing belt, and a diameter of a release portion of a fixing portion becomes small.

From the results of Table 5, the following is understood. Even in a case in which the base is changed to polyimide film, fixing in example 4 may be conducted at a lower temperature than comparative example 4 similar to examples 1 to 3 of the case of type 6000 <70 W>.

Further, from the results of examples 1 to 3 of Table 3 (type 6000 <90 W>) and Table 4 (type 6000 <58 W>), the following is understood. Even in the case of type 6000 <90 W>, fixing may be conducted by raising the temperature 10° C. compared to the case of type 6000 <58 W>. At a temperature setting of 135° C., responding to all sheet types is possible.

By contrast, comparative example 1 cannot conduct fixing on a sheet having a ream weight of 90 kg. In other words, comparative example 1 cannot respond to the sheet having the ream weight of 90 kg with only small changes to the temperature setting. There is a need to conduct other operations such as decreasing linear velocity to make comparative example 1 respond to the sheet having the ream weight of 90 kg.

Regarding comparative examples 2 to 3, the fixing temperature is 20° C. to 25° C. higher than examples 1 to 3. The difference in fixable temperature of comparative examples 2 to 3 between type 6000 <90 W> and type 6000 <58 W> is 15° C., and is 5° C. higher than examples 1 to 3.

According to at least one embodiment of the present invention, there is provided the electrophotographic fixing device in which the fixing temperature may be made low and responds to change of the sheet type by conducting small changes to the temperature setting. In other words, the electrophotographic fixing device has a simple configuration and responds to change of the sheet type by conducting small temperature changes to change the nip shape and pressure of the nip.

What is claimed is:

1. An electrophotographic fixing device, comprising:
a pressure roller; and
a fixing rotary member disposed at a fixed distance away from the pressure roller, the fixing rotary member including a layer formed of an elastic body, the elastic body including carbon fibers and hole portions,
wherein the electrophotographic fixing device controls pressure of a nip between the pressure roller and the fixing rotary member by a temperature setting according to a sheet type.

2. The electrophotographic fixing device of claim 1, further comprising a pair of rigid members to sandwich the fixing rotary member, wherein the electrophotographic fixing device controls the pressure of the nip by temperature of a gas of the hole portions.

3. The electrophotographic fixing device of claim 1, wherein a base of the fixing rotary member is a heat resistant resin film or a metal belt.

4. The electrophotographic fixing device of claim 1, wherein the fixing rotary member includes a layer formed of a fluororesin as a release layer at an outermost surface of the fixing rotary member.

5. The electrophotographic fixing device of claim 1, further comprising a heating member provided inside the fixing rotary member.

6. A fixing rotary member employed for an electrophotographic fixing device including a sheet type setting device, the fixing rotary member comprising a layer formed of an elastic body, the elastic body including pitch-based carbon fibers and hole portions.

7. An image forming apparatus comprising the electrophotographic fixing device of claim 1.

8. An electrophotographic fixing method used in the electrophotographic fixing device of claim 1, the method comprising:
setting a temperature of a predetermined table with respect to a value from a sheet type setting device; and
starting to fix after confirming the electrophotographic fixing device has reached the temperature set by the setting.
